(19) United States
(12) Patent Application Publication
(10) Pub. No.: US 2026/0260776 A1
(43) Pub. Date: Sep. 3, 2026

(54) ZONED NEUTRAL ATOM QUANTUM COMPUTER SCHEDULE OPTIMIZATION

(71) Applicant: Microsoft Technology Licensing, LLC, Redmond, WA (US)

(72) Inventors: David Alexander AASEN, Santa Barbara, CA (US); Alexander VASCHILLO, Redmond, WA (US); Marcus Palmer DA SILVA, Redmond, WA (US); Ivan BASOV, Redmond, WA (US); Haris GAVRANOVIC, Seattle, WA (US); Diego Olivier FERNANDEZ, Copenhagen (DK)

(73) Assignee: Microsoft Technology Licensing, LLC, Redmond, WA (US)

(21) Appl. No.: 19/066,949

(22) Filed: Feb. 28, 2025

(51) Int. Cl. G21K 1/30; G06N 10/40

(52) U.S. Cl. CPC G21K 1/30; G06N 10/40

(57) ABSTRACT

The invention relates to neutral atom quantum computers having a zoned architecture that includes a storage zone and an interaction zone as part of an array of atoms that form the quantum register in an optical lattice. A schedule optimizer determines an optimized atom schedule for moving atoms between the storage zone and the interaction zone using optical tweezers generated by an optical trap generator responsive to the optimized atom schedule. The schedule optimizer may be implemented according to several variations of algorithms that include an annealing solver and a mathematical optimization engine. The schedule optimizer receives an objective function that includes selectable factors that correlate to minimizing the logical error rate for a set of operational tasks, various hardware constraints such as zone geometries and circuit schedules.

### BACKGROUND

Quantum computers typically make use of quantum-mechanical phenomena, such as superposition and entanglement, to perform operations on data. Quantum computers may be different from digital electronic computers based on transistors. For instance, whereas digital computers require data to be encoded into binary digits (bits), each of which is always in one of two definite states (0 or 1), quantum computation uses quantum bits (qubits), which can be in superpositions of states.

Quantum computing research has made significant progress in both quantum algorithms and quantum hardware that have shown significant progress toward improving the computational power and reliability of quantum computing. Among the various quantum computing platforms, advances in laser technology have rapidly advanced the development of neutral atom architectures as a scalable and reliable solution for gate-based quantum computing. Optically trapped neutral atoms that include Rubidium, Cesium, Ytterbium, and Strontium offer strong candidates in which to create new quantum computing architectures. Qubits are encoded into long-lived states of a neutral atom such as a nuclear spin state. Selectively exciting an atom from an encoded state into a Ryberg state enables a short-range interaction between atoms which can be used for realizing entangled gates. Optical tweezers and optical lattices enable atom movement and correspondingly long range two-qubit (2Q) gate connectivity within an optical trap array. High-fidelity flexible gates combined with long qubit lifetimes are making the gate-based neutral atom quantum computer an increasingly viable solution.

A more recent development in neutral atom quantum computing is the zoned architecture that divides the optical trap array into various zones that support different operations on the trapped neutral atoms in a way that improves parallelism, scalability and efficiency while reducing quantum errors during quantum computation. The storage zone and the entanglement zones have been identified of greatest interest for various research efforts to achieve these goals through the optimized movement of atoms between the storage and entanglement zones to support a desired quantum computation. Despite the common use of zone names, the specific neutral atom architectures, hardware constraints, and optical tweezer operation drive different algorithmic choices available to the designer that differ sharply across competing approaches. One such approach includes a neutral atom architecture that includes the use of a doublon structure for the entanglement zone that is formed by set of fixed optical traps in which a desired set of atoms are placed prior to excitation by a two-qubit (2Q) gate laser. It would be desirable to provide an optimized atom schedule that orchestrates the movement of atoms between the entanglement zone and the storage zone according to the unique requirements of the zoned architecture.

### SUMMARY

An example system for configuring an array of atoms for performing a quantum computation, according to the disclosure, includes a quantum register including an optical trap array having a plurality of zones, the plurality of zones including an interaction zone and a storage zone; a scheduling optimizer for receiving a plurality of constraints and determining an optimized atom schedule that optimizes a value of an objective function that correlates to minimizing a logical error rate while performing the quantum computation and respecting the plurality of constraints including hardware constraints that include an interaction zone geometry, a storage zone geometry, and movement constraints within the array of atoms between the interaction zone and the storage zone, the interaction zone geometry including doublons, circuit scheduling that includes initial qubit placement in the optical trap array and gate groupings in the doublons in the interaction zone, and qubit groupings for simultaneous moves between the interaction zone and the storage zone; and an optical trap generator for deflecting a trapping laser into a first direction and a second direction to form the optical trap array, the optical trap generator coupled to the scheduling optimizer to receive the optimized atom schedule and move a set of atoms of the array of atoms between the doublons in the interaction zone and the storage zone in the optical trap array responsive to the optimized atom schedule.

An example method for configuring an array of atoms for performing a quantum computation, according to the disclosure, includes providing a quantum register including an optical trap array having a plurality of zones, the plurality of zones including an interaction zone and a storage zone, receiving a plurality of constraints at a scheduling optimizer, determining by the scheduling optimizer, an optimized atom schedule that optimizes a value of an objective function that correlates to minimizing a logical error rate while performing the quantum computation and respecting the plurality of constraints including hardware constraints that include an interaction zone geometry based on doublons, a storage zone geometry, and movement constraints within the array of atoms between the interaction zone and the storage zone, the interaction zone geometry including doublons, circuit scheduling that includes initial qubit placement in the optical trap array, gate groupings in the doublons in the interaction zone, and qubit groupings for simultaneous moves between the interaction zone and the storage zone; and receiving the optimized atom schedule by an optical trap generator coupled to the scheduling optimizer, deflecting a trapping laser into a first direction and a second direction to form the optical trap array using the optical trap generator, and moving the array of atoms by the optical trap generator between the doublons in the interaction zone and the storage zone in the optical trap array responsive to the optimized atom schedule.

An example neutral atom quantum computer having a zoned architecture comprising an interaction zone including doublons, and a storage zone, according to the disclosure includes a quantum register including an optical trap array having a plurality of zones, the plurality of zones including the interaction zone and the storage zone, a scheduling optimizer for receiving a plurality of constraints and determining an optimized atom schedule that optimizes a value of an objective function that correlates to minimizing a logical error rate while performing a quantum computation and respecting the plurality of constraints including hardware constraints that include an interaction zone geometry, a storage zone geometry, and movement constraints within an array of atoms between the interaction zone and the storage zone, the interaction zone geometry including doublons, and circuit scheduling that includes initial qubit placement in the optical trap array, gate groupings in the doublons in the interaction zone, and qubit groupings for simultaneous moves between the interaction zone and the storage zone; and an optical trap generator for deflecting a trapping laser into a first direction and a second direction to form the optical trap array, the optical trap generator coupled to the scheduling optimizer to receive the optimized atom schedule and move the array of atoms between the doublons in the interaction zone and the storage zone in the optical trap array responsive to the optimized atom schedule.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a block diagram of a quantum computing stack, including application, software, and quantum hardware layers, according to the disclosure.

FIG. 2 is a hardware diagram showing an orthogonal view of the quantum hardware layer, including a quantum register with a plurality of zones.

FIG. 3 is an exemplary architecture diagram of an interaction zone and a storage zone.

FIG. 4 is an illustration of a portion of the interaction zone and the storage zone of FIG. 3 showing atom movement.

FIG. 5 is a block diagram showing the operation of a schedule optimizer.

FIG. 6 is a flow diagram showing the operation of an annealing solver in the schedule optimizer of FIG. 5.

FIG. 7 is a flow diagram showing the operation of a mathematical optimization engine in the schedule optimizer of FIG. 5.

### DETAILED DESCRIPTION

Exemplary aspects disclosed herein include a system for configuring an array of atoms for performing a quantum computation. Neutral atom quantum architectures have rapidly evolved from analog configurations to support digital gate-based computation that provides substantial capability to handle more complex quantum computing tasks in a scalable way. The advantage of using neutral atoms as qubits relies on their configurability, with increasingly large numbers of atoms that can be placed in optical trap arrays in a quantum register and the all-to-all connectivity of neutral atoms enabled by movement using optical tweezers. At the same time, low error rates and high two-qubit (2Q) gate fidelity are possible given the inherent resistance of neutral atoms to external interference.

A more recent advancement in neutral atom quantum computing architecture involves the segmentation of the optical trap array into multiple zones, with each zone having a particular set of functionalities that are implanted as part of the quantum computation. Zones that have been identified include storage, interaction, reload, qubit preparation, single qubit gate, measurement zone, and cooling. Each zone is physically separate, with corresponding zone geometries chosen according to factors that include sufficient isolation to minimize undesirable interactions, and physical distances involved with moving atoms among the zones. The zones may be part of the same optical trap array or supported with multiple optical trap arrays depending on the quantum hardware choice. The optical trap array is implemented as a static optical tweezer trap.

Atoms are moved between locations of the optical trap array using mobile optical tweezers which enables arbitrary connectivity between large numbers of qubits. Single-cubit operations and qubit storage are performed in a register array. Two-qubit gates are performed in the interaction zone which is implemented as an array of doublons. A doublon is created by a pair of static optical tweezers in an optical trap array that are placed sufficiently close that the pair of atoms in the doublon will become entangled responsive to a 2Q gate pulse such as from a Rydberg laser to form the two-qubit gate.

Hardware constraints involve the combination of choices made for the quantum hardware. An optical trap generator may be implemented using a crossed acousto-optic deflector (xAOD) to generate the mobile optical tweezers for moving the atoms and a spatial light modulator (SLM) for generating the static optical tweezer array. The xAOD and the SLM operate to deflect the trapping laser in a first direction and a section direction (x and y) and each of their outputs are combined in a polarizing beam splitter (PBS) to form the optical trap generator. The output of the optical trap generator is applied via a dichroic mirror to form the quantum register and the optical trap array in a vacuum chamber.

Measurements are performed by moving a selected set of atoms to the measurement zone in the optical trap array and using a camera coupled via the dichroic mirror to image the state of the set of atoms in the measurement zone through luminescence. The state of each atom of the set of atoms is read as either |0>, |1> or “lost”.

The described configuration for the optical trap generator has a corresponding set of hardware constraints that must be met during execution of the quantum computation. Each of the zones of the optical trap array will have a corresponding zone geometry. The arrangement of zones within the optical trap array and each zone geometry are further hardware constraints which will be included as part of the quantum architecture. Another hardware constraint is the movement limitation for atoms such that the paths of each of the atoms being moved cannot cross in transit between the zones. Each atom moved to from the storage zone maintains a corresponding home location to which it is returned following an operation in the interaction zone. The operation of the interaction zone involves applying the 2Q gate pulse to each of the doublons in the array to create the entanglements between the qubits. Following the operation, the atoms in each doublon are returned to the storage zone.

Circuit scheduling is a pre-processing operation performed to link a desired gate-based quantum computation, such as a quantum circuit, a quantum error correction, or a logical algorithm, into an initial qubit placement in the optical trap array, the gate groupings in the interaction zone and the storage zone, and qubit groupings for simultaneous moves between the interaction zone and the storage zone. Circuit scheduling operates to assign one-qubit and two-qubit gates according to the quantum computation that includes a sequence of gates and stages. Atoms from the storage zone are moved as a group using the mobile optical tweezers to populate the desired array of doublons in the interaction zone, such as from the same row of the storage zone to a corresponding row in the interaction zone to populate the array of doublons.

An objective function provides a mathematical method for selecting among a desired set of objectives that can be optimized during a quantum computation. The value returned by the objective function is chosen to correlate to an overall objective of minimizing the logical error rate for a given set of quantum computations. Examples of objectives that may be selected, either singularly or in combination, include: minimize the circuit execution time, minimize the total error accrued by a given circuit, minimize the total number of moves an atom undergoes, minimize the total distance the atoms need to travel, maximize the number of parallel movements, maximize the number of simultaneous gates, and maximize the amount of time a qubit spends in the measurement basis.

A schedule optimizer includes a selected set of algorithms that are applied to create an optimized atom schedule that provides a complex sequence of atom trajectories across the zones of the optical trap array to enable the desired quantum computation while complying in an optimal way with the circuit scheduling, the hardware constraints, and the desired set of objectives from the objective function. The set of algorithms include an annealing solver and a mathematical optimization engine that may be applied singularly or in combination to produce the optimized atom schedule.

Further exemplary aspects disclosed herein include the annealing solver applied in the schedule optimizer that is designed to be flexible for changes in the hardware constraints as well as updates to the objective function that fundamentally change the operating characteristics of the quantum hardware, particularly as the capabilities of the optical trap array continue to evolve. The annealing solver handles a very large search space across the circuit scheduling, hardware constraints, and objective function constraints to produce the optimized atom schedule. The search space is decomposed into multiple subspaces, the relationships between those subspaces are defined, and the optimization problem then becomes a hierarchy of smaller problems. For each subproblem, a heuristic method may be designed or meta-heuristics are alternatively applied. The upper levels of the search space hierarchy are pruned as the optimization process moves down through the hierarchy. In this way, the annealing solver is applied to produce a tangible result in the form of the optimized atom schedule that drives the physical layout and sequenced movement of atoms across the optical trap array to enable the desired quantum computation.

Further exemplary aspects disclosed herein include the mathematical optimization engine applied in the scheduling optimizer, either as an alternative to or in combination with the anneal solver. The mathematical optimization engine is designed to handle the atom movement scheduling problem using selected combinations of integer programming, constraint programming, constraint optimization, and related optimization engines desired to identify feasible solutions out of a very large set of candidates, where the problem can be modeled in terms of arbitrary constraints. The process of solving the scheduling problem using the mathematical optimization engine includes modeling, in which the problem is translated into the type of equations that are suitable for the mathematical optimization engine and then feed the equations to the mathematical optimization engine for solving. When the problem is overly complex for the modeling step, decomposition is performed to divide the problem into successive problems that are solved by the mathematical optimization engine to produce partial solutions. The partial solutions are re-assembled to obtain a global solution that becomes the optimized atom schedule that drives the physical layout and sequenced movement of atoms across the optical trap array to enable the desired quantum computation.

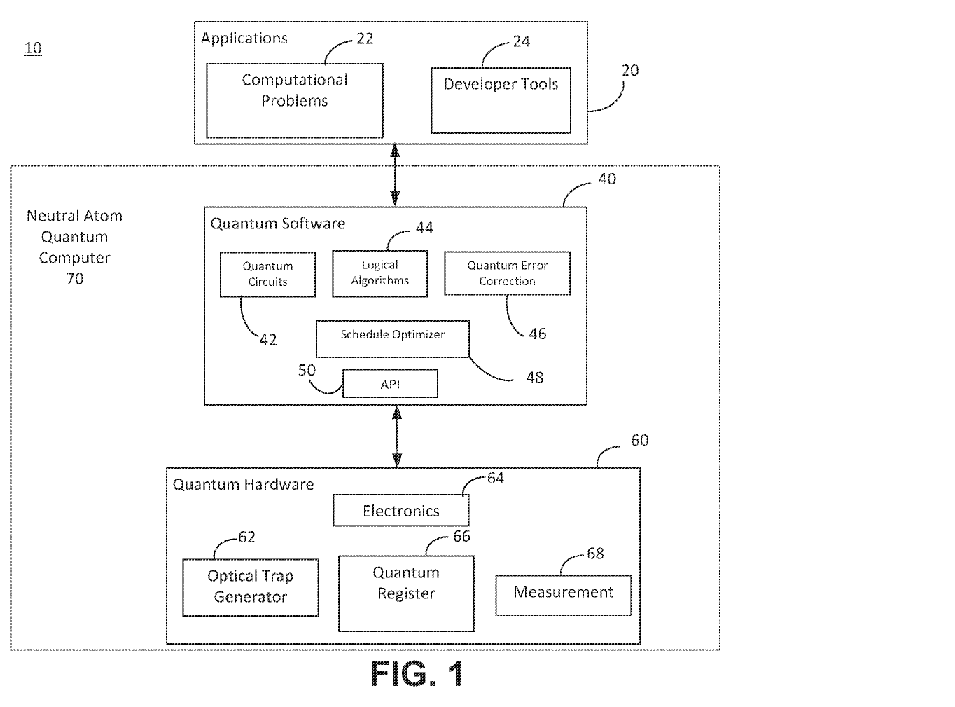

FIG. 1 is a block diagram of a quantum computing stack 10, including applications 20, quantum software 40, and quantum hardware 60. The applications 20 is the top layer of the quantum computing stack 10 and includes software applications related to computation problems 22 and developer tools 24. Computation problems 22 include a variety of software programs and services that seek to harness the advantages of quantum computing, including drug development, financial modeling, weather forecasting, and artificial intelligence. Many of these software applications work on a hybrid principle that uses both classical computing and quantum computing to most effectively deliver desired results. Developer tools 24 include a large and growing ecosystem of software tools, development environments, and software frameworks that typically run on a classical computer with the specific purpose of simulating and implementing quantum computations. In one implementation, many of the developer tools 24 are open-source based and are hosted across a large community of developers.

The quantum software 40 includes quantum circuits 42, logical algorithms 44 and quantum error correction 46 as examples of more specialized quantum libraries, functions, and middleware that are available to the applications 20 to provide quantum functionality and access to the quantum hardware at an abstracted level via an application programming interface (API) 50. A schedule optimizer 48, as will be explained in further detail below, serves to optimize the operation of the quantum hardware 60, specifically implemented as a neutral atom quantum computer, responsive to the requirements presented by the applications 20 and the quantum software 40 to perform quantum computations.

The quantum hardware 60 includes an optical trap generator 62, electronics 64, quantum register 66, and measurement 68. The quantum hardware 60 represents a highly specialized, implementation-specific quantum computer architecture. The disclosed invention focuses specifically on a neutral-atom quantum computer, the neutral atom being Ytterbium and the quantum register 66 including an optical trap array generated by the optical trap generator 62, with the optical trap array segmented into a plurality of zones as will be explained in more detail below. The electronics 64 are also highly specialized and adapted to the quantum computer architecture. The electronics 64 include functionality for receiving the optimized atom schedule via the API 50 from the schedule optimizer 48 and in turn providing control signals to the optical trap generator 62 to drive the physical layout and sequenced movement of atoms across the optical trap array in the quantum register 66 to enable the desired quantum computation. The measurement 68 includes conducting measurements by moving a selected set of atoms to a measurement zone in the optical trap array and using a camera to image the state of the set of atoms in the measurement zone through luminescence. The state of each atom of the set of atoms is read as any of |0>, |1> or “lost”. The measurement results are then returned via the API 50 to the quantum software 40 that may perform addition processing such as in the quantum error correction 46 before providing the measurements to the applications 20.

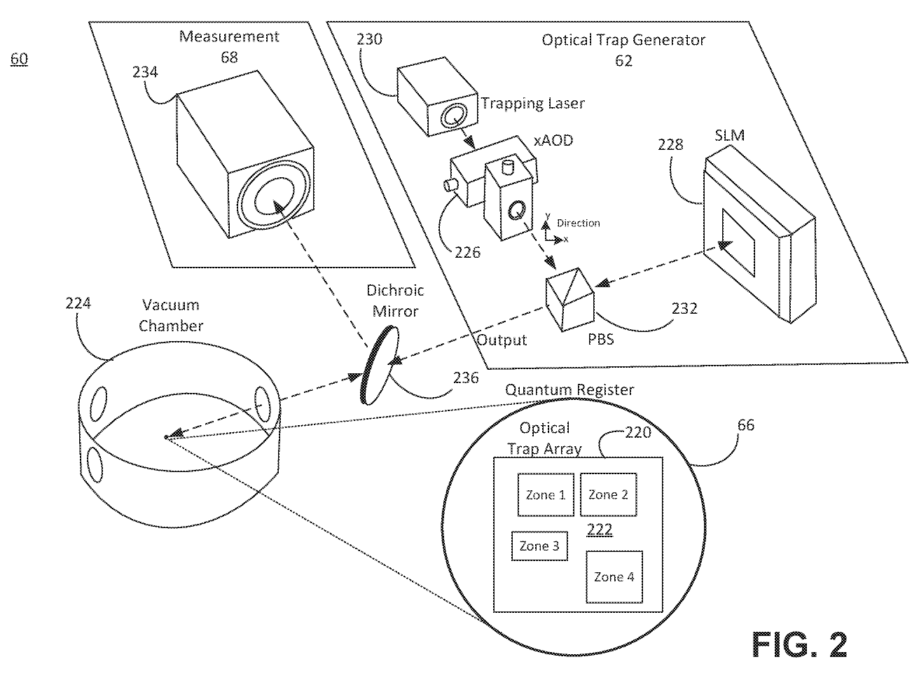

FIG. 2 is a hardware diagram showing an orthogonal view of the quantum hardware 60, including a quantum register 66 that includes an optical trap array 220 with a plurality of zones 222 labeled Zone 1-4 but may include any of an interaction zone, a storage zone, a reload zone, a qubit preparation zone, a single qubit gate zone, a measurement zone, and a cooling zone. The arrangement and geometry of the plurality of zones 222 are chosen according to engineering considerations such as minimizing atom travel distance between zones, minimizing cross-talk between qubits, and minimizing noise and sources of error. The quantum register 66 including the optical trap array 220 is formed inside a vacuum chamber 224 that further includes the neutral atoms that populate the optical trap array 220.

The optical trap array 220 is formed by the optical trap generator 62 that includes an xAOD 226 to generate the mobile optical tweezers for moving the atoms and an SLM 228 for generating the static optical tweezer array. The xAOD 226 and the SLM 228 operate to deflect a trapping laser 230 in a first direction and a section direction (x and y) and the outputs of the xAOD 226 and the SLM 228 are combined in a PBS 232 to form the optical trap generator 62. The output of the optical trap generator 62 is applied via a dichroic mirror 236 to form the quantum register 66 and the optical trap array 220 in the vacuum chamber 224. The measurement68 includes a camera 234 coupled via the dichroic mirror 236 to view the quantum register 66 to image the state of the set of atoms in the optical trap array 220 through luminescence. The state of each atom of the set of atoms is read as any of |0>, |1> or “lost”. The measurement results are then returned via the API 50 to the quantum software 40.

In an implementation of the optical trap generator 62, the xAOD 226 forms a set of mobile optical tweezers that move atoms among selected locations in the optical trap array 220 that is formed by a set of fixed optical tweezers generated by the SLM 228. The xAOD 226 generates a flexible 2D array that can dynamically adjust its spacing, subject to various movement constraints include atoms that can only move within their assigned row or column, with crossing between rows or columns during movement. The xAOD 226 modulates its row and column spacing to expand and contract like a web to facilitate atom movement within the optical trap array 220. The SLM 228 generates a fixed lattice of optical wells in which atoms are loaded into, with each well holding one atom. Other implementations of the optical trap generator 62 may include the ability to move the atoms using the SLM 228 in combination with the xAOD 226.

A neutral atom quantum computer 70 (FIG. 1) having a zoned architecture may be collectively described as the quantum software 40 including the schedule optimizer 48 in combination with the quantum hardware 60, including the quantum register 66 having the optical trap array 220 with the plurality of zones 222 labeled Zone 1-4, as described above in FIG. 2, and with the additional aspects further described below.

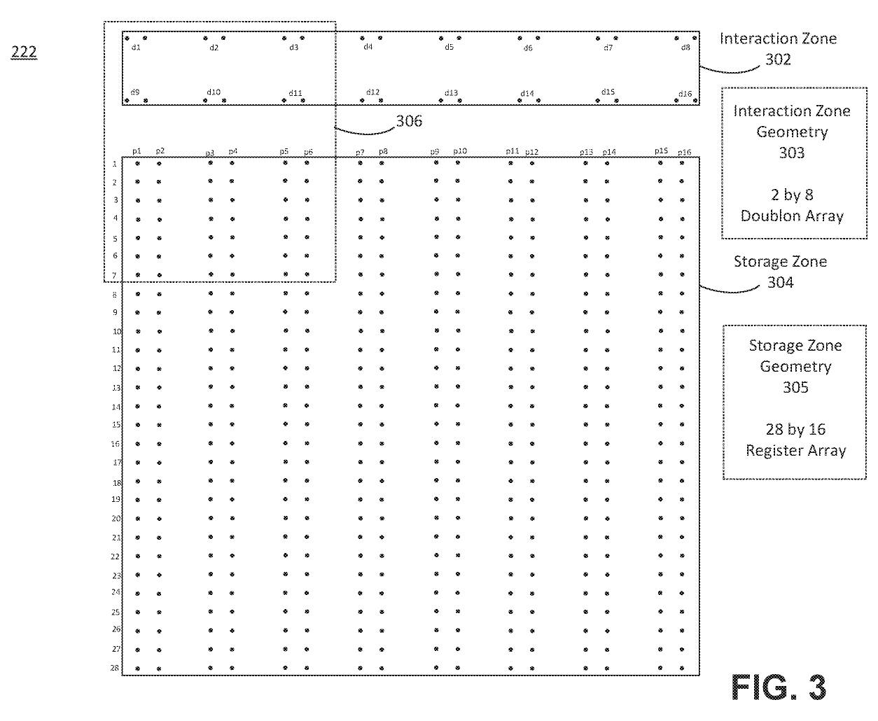

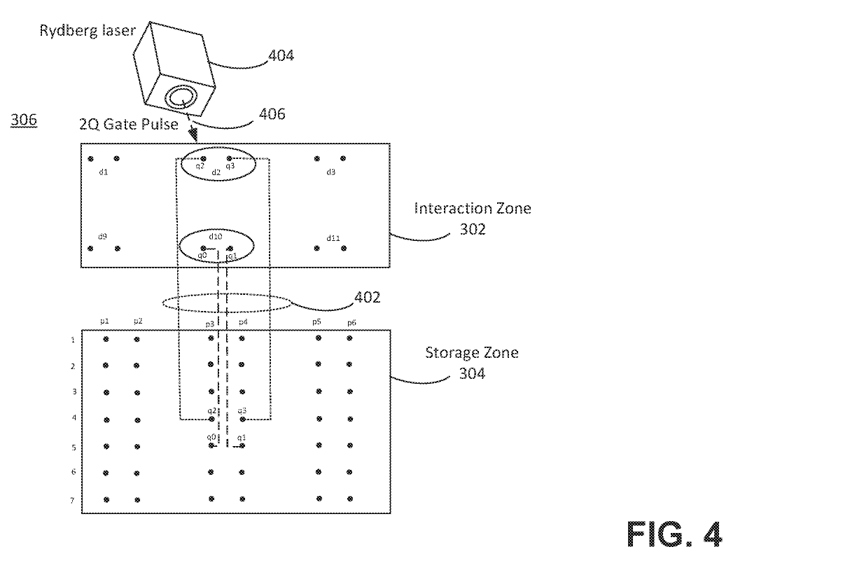

FIG. 3 is an exemplary architecture diagram of an interaction zone 302 and a storage zone 304 from the zones 222 shown in FIG. 2. The storage zone 304 has a storage zone geometry 305 that is shown as a 28 by 16 register array, which is a two-dimensional planar array generated by the SLM 228 as part of the optical trap array 220. The geometry of the storage zone geometry 305 includes a selected set of distances between the rows and columns of the array that minimize unwanted interactions between adjacent atoms while minimizing the distance the atoms must travel during move operations. The number of rows and columns in the storage zone geometry 305 are readily variable and may be chosen in a manner that optimizes the operation of the quantum hardware 60 as configured. The interaction zone 302 has an interaction zone geometry 303 that is shown as a 2 by 8 doublon array, which is also a two-dimensional planar array generated by the SLM 228 as part of the optical trap array 220. Two-qubit gates are performed in the interaction zone 302 in the array of doublons d1-d16. Each of the doublons d1-d16 is created by a pair of static optical tweezers generated by the SLM 228 in the optical trap array 220, with the pair of optical wells in the each of the doublon d1-d16 placed sufficiently close to each other so that a pair of atoms in the any of the doublons d1-d16 will become entangled responsive to a 2Q gate pulse such as from a Rydberg laser to form two-qubit gate. The 2Q gate pulse is applied to all of the doublons d1-d16 simultaneously. The distance between each of the doublons d1-d16 is selected to minimize undesirable interactions between each doublon while also minimizing the distance that atoms must travel between the storage zone 304 and the interaction zone 302. A portion 306 of the interaction zone 302 and the storage zone 304 showing an exemplary atom movement operation is shown in FIG. 4.

FIG. 4 is an illustration of the portion 306 of the interaction zone 302 and the storage zone 304 of FIG. 3 showing an atom movement operation 402. During the atom movement operation 402, a pair of atoms located at q0 and q1 and a second pair of atoms located at q2 and q3 in the storage zone 304 are moved to corresponding rows and columns in the interaction zone 302 and placed in the doublons d10 and d2 as shown. The atom movement operation 402 is performed by the xAOD 226 that generates the mobile optical tweezers. Many such atom movement operations 402 can be performed in a parallel, scalable manner. When a desired set of doublons d1-d16, in this case d2 and d10, are loaded with pairs of atoms, a Rydberg laser 404 generates a 2Q gate pulse 406 to the set of doublons d1-d16, that implements 2Q gates on the atoms q0 and q1 in doublon d10 and atoms q2 and q3 in doublon d2. Following the 2Q gate operation, the atoms q0-q4 are moved back during another atom movement operation 402 to the same locations they were taken from in the storage zone 304, which are referred to as the home locations for each of the atoms q0-q4.

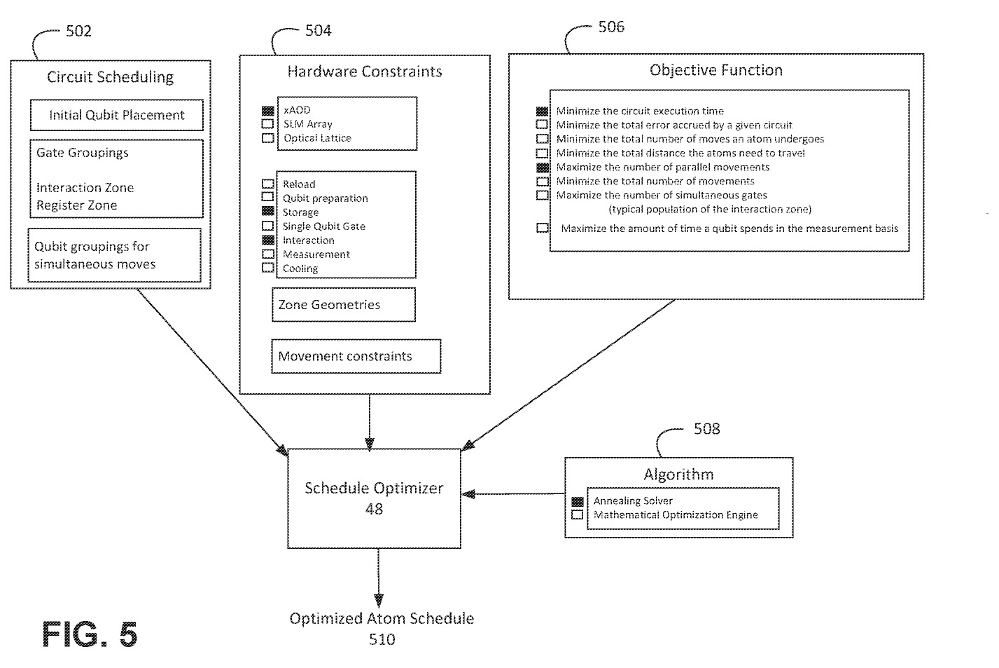

FIG. 5 is a block diagram showing the operation of the schedule optimizer 48 that is coupled to receive circuit scheduling 502, hardware constraints 504, and an objective function 506, along with an algorithm 508, to determine an optimized atom schedule 510. The circuit scheduling 502 is pre-processing operation performed to link a desired gate-based quantum computation, such as a quantum circuit 42, a quantum error correction 44, or a logical algorithm 46 generated by the quantum software 40 to a set of initial configurations of atoms in the quantum register 66 prior to running the quantum computation. The circuit scheduling 502 may include the initial qubit placement in the optical trap array 220, gate groupings in the interaction zone 302 and the storage zone 304, and qubit groupings for simultaneous moves. As a further example, a quantum computation received by the circuit scheduling 502 may include a circuit schedule for quantum error correction circuit having an input circuit with a set of dependent gates and a set of independent gates. The schedule optimizer 48 receives the circuit schedule and may operate to preserve the order of the set of dependent gates while optimizing the order of the independent gates.

The hardware constraints 504 reflect the configuration of the quantum hardware 60 as reflected in FIG. 2. The optical trap generator 62 is configured with an xAOD 226 to generate the mobile optical tweezers for moving the atoms and an SLM 228 for generating the static optical tweezer array form one set of hardware constraints. Related to the optical trap generator 62 constraints are movement constraints, such as how many atoms can be moved in parallel and how far across the optical trap array 220. Another configuration selection includes which subset of the plurality of zones 222 are to be optimized for. As the quantum hardware changes and evolves, the hardware constraints 504 will change accordingly.

As disclosed above, the atom movements between the interaction zone 302 and the storage zone 304 are considered in detail and can be optimized. Other zones of the plurality of zones 222 could also be selected, which would alter the optimized atom schedule 510 accordingly. Another configuration selection are the geometries of the zones 222, both in terms of numbers of rows and columns, and also how the zones 222 are placed within the optical trap array 220.

The objective function 506 provides a mathematical method for selecting among a desired set of objectives that can be optimized during a quantum computation. The value returned by the objective function is chosen to correlate to an overall objective of minimizing the logical error rate for a given set of quantum computations. Examples of objectives that may be selected, either singularly or in combination, include: minimize the circuit execution time, minimize the total error accrued by a given circuit, minimize the total number of moves an atom undergoes, minimize the total distance the atoms need to travel, maximize the number of parallel movements, maximize the number of simultaneous gates, and maximize the amount of time a qubit spends in the measurement basis. While any combination of these objectives could be selected and the schedule optimizer 48 would responsively determine the optimized atom schedule 510, practical considerations would likely indicate optimizing on a smaller subset, such as minimizing the circuit execution time while maximizing the number of parallel movements of atoms.

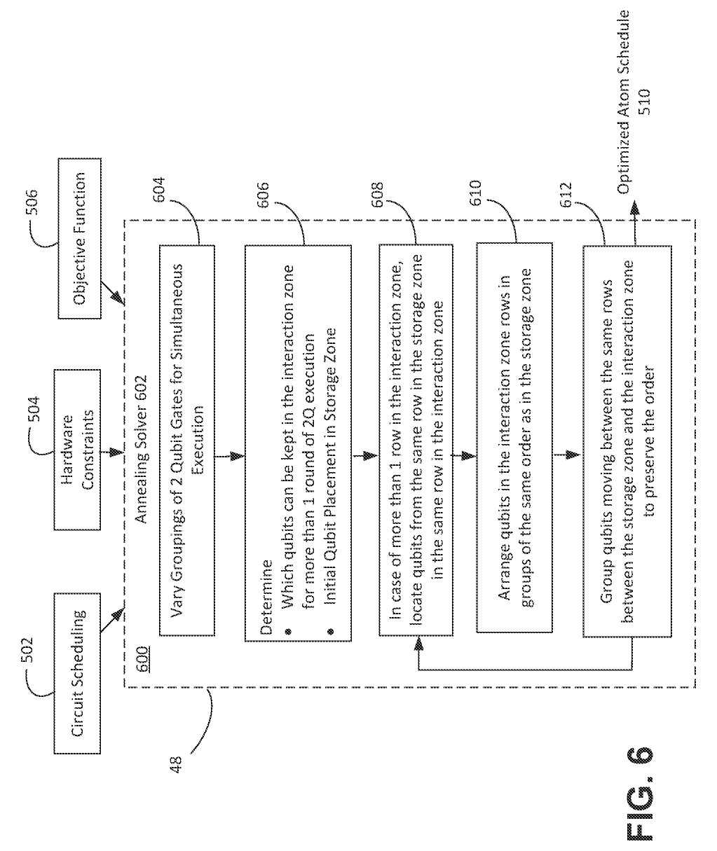

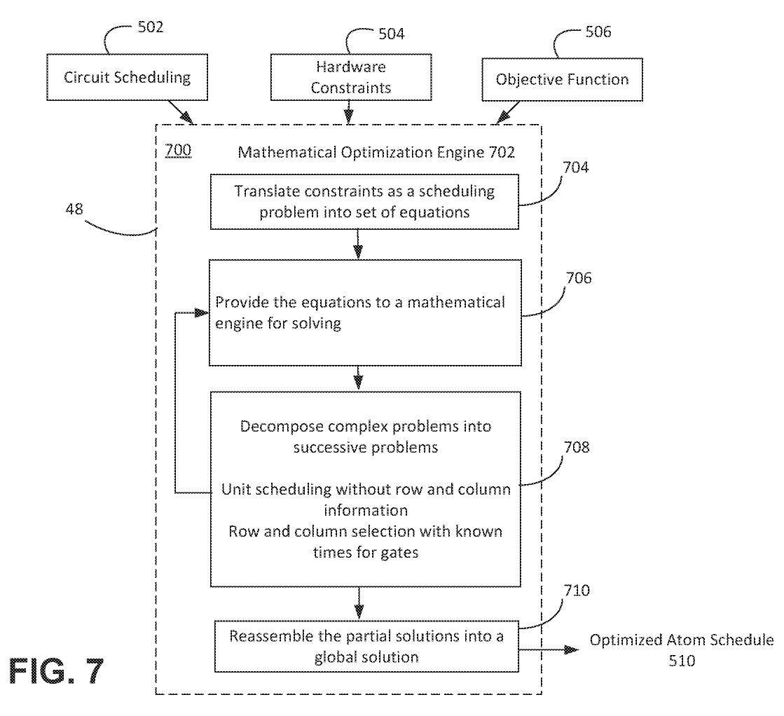

A further input the schedule optimizer 48 is the algorithm 508 which provides a selected set of algorithms to apply to the constraint problem to determine the optimized atom schedule 510. The set of algorithms includes an anneal solver, discussed further in FIG. 6 below, and a mathematical optimization engine, discussed further FIG. 7 below, that are applied to create an optimized atom schedule that provides a complex sequence of atom trajectories across the zones of the optical trap array to enable the desired quantum computation while complying in an optimal way with the circuit scheduling, the hardware constraints, and the desired set of objectives from the objective function. The annealing solver and the mathematical optimization engine may be applied singularly or in combination to produce the optimized atom schedule. While various other constraint solving algorithms could also be chosen, the set of algorithms in algorithm 508 were developed to meet requirements of the quantum hardware 60 as disclosed to determine the optimized atom schedule 510.

FIG. 6 is a flow chart of an example process 600 for determining the optimized atom schedule 510 according to the techniques disclosed herein which can be implemented by an annealing solver 602 in the schedule optimizer 48 as discussed in the preceding examples.

The process 600 includes an operation 604 of varying groupings of 2-qubit gates for simultaneous execution. Grouping 2-qubit gates together is the top layer of a multi-layer optimization in which the overall optimization problem is decomposed into multiple subproblems. The number of optimization layers corresponding to each subproblem is a function of the interaction zone geometry that includes the number of rows in the interaction zone 302, with 5 optimization layers corresponding to one row in the interaction zone 302 and 7 optimization layers corresponding to two rows in the interaction zone 302.

The process 600 includes an operation 606 for determining which qubits can be kept in the interaction zone for more than one round of two-qubit execution. The operation 606 includes further determining the initial qubit placement in the storage zone. Simultaneous one-qubit and two-cubit execution is possible between the interaction zone 302 and the storage zone 304. One-qubit and two-qubit gates can be moved simultaneously between the interaction zone 302 and the storage zone 304.

The process 600 includes an operation 608 that, in the case where there is more than one row in the interaction zone, locating qubits from the same row in the storage zone for moving to the corresponding row in the interaction zone. The goals of the objective function 506 include making the grouping of the one-qubit and two-qubit gates in execution and movement as efficient as possible.

The process 600 includes an operation 610 for arranging qubits in the interaction zone 302 in groups of the same order as in the storage zone 304. Satisfying the constraint to minimize the movement distance involves determining which qubits would go to the first or the second row in the interaction zone 302, which could be done in one movement operation 402 or with multiple movement operations 402.

The process 600 includes an operation 612 for grouping qubits moving between the same rows between the storage zone 304 and the interaction zone 302 to preserve the order. The geometry of one-qubit and two-qubit groups can be varied, such as arranging them across the respective rows from left to right. For the hardware constraints 504 provided to the schedule optimizer, heuristics can be developed and provided to the annealing solver 602 to assist in the optimization. The operations 608, 610, and 612 will iterate according to the number of optimization layers to determine the optimized atom schedule 510.

FIG. 7 is a flow chart of an example process 700 for determining the optimized atom schedule 510 according to the techniques disclosed herein which can be implemented by a mathematical optimization engine 702 in the schedule optimizer 48 as discussed in the preceding examples.

The process 700 includes an operation 704 for translating constraints as a scheduling problem into set of equations. The problem is defined at the highest level of defining a machine that is performing quantum computing through a sequence of one-qubit and two-qubit gate operations according to a process that is error-prone, with the overall objective provided by the objective function 506 to minimize errors introduced through the scheduling of atom movement. The physical manipulation of atoms that becomes atom movement operations 402 and associated error modeling are translated into a set of equations.

The process 700 includes an operation 706 for providing the equations to a mathematical engine for solving. The general approach can be taken through constraint programming, also called mathematical programming, that is the process of identifying feasible solutions out of a very large set of candidates, where the problem can be modeled in terms of arbitrary constraints. The technological constraints derived from the hardware constraints 504 and the circuit scheduling 502 are modeled as arbitrary constraints according to a generic model. Mathematical engines or ‘solvers’ available under the class of constraint programming (CP) solvers include Google CP/SAT and Microsoft Z3 Satisfiability Modulo Theories (SMT) solvers.

The process 700 includes an operation 708 for decomposing complex problems into successive problems, including unit scheduling without row and column information along with row and column selection with known times for gates. The mathematical model and the equations provided to the solver provide one part of the solution. The process of decomposition is done through successive mathematical modeling and fine-tuning to further provide equations to the mathematical engine.

The process 700 includes an operation 710 for reassembling the partial solutions into a global solution to determine the optimized atom schedule 510. The operations 706 and 708 will iterate across a span of solving and decomposition until a desired set of solutions is arrived upon. The partial solutions are re-assembled to obtain a global solution to determine the optimized atom schedule 510 that drives the physical layout and sequenced movement of atoms across the optical trap array 220 to enable the desired quantum computation. The number of iterations of operations 706 and 708 required is variable but depends on the complexity of the sequence of the optimized atom schedule 510.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The disclosure provides many different embodiments, or examples, for implementing different features of the provided subject matter. Specific examples of components and arrangements are described to simplify the present disclosure. These are merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. Further, spatially relative terms, such as “beneath,” “below,” “lower,” “above,” “upper,” “back,” “front,” “top,” “bottom,” and the like, are used herein for ease of description to describe one element or feature's relationship to another element(s) or feature(s) as illustrated in the figures. The spatially relative terms are intended to encompass different orientations of the device in use or operation in addition to the orientation depicted in the figures.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system for configuring an array of atoms for performing a quantum computation, the system comprising:
a quantum register including an optical trap array having a plurality of zones, the plurality of zones including an interaction zone and a storage zone;
a scheduling optimizer for receiving a plurality of constraints and determining an optimized atom schedule that optimizes a value of an objective function that correlates to minimizing a logical error rate while performing the quantum computation and respecting the plurality of constraints including:
hardware constraints that include an interaction zone geometry, a storage zone geometry, and movement constraints within the array of atoms between the interaction zone and the storage zone, the interaction zone geometry including doublons,
circuit scheduling that includes initial qubit placement in the optical trap array and gate groupings in the doublons in the interaction zone, and
qubit groupings for simultaneous moves between the interaction zone and the storage zone; and
an optical trap generator for deflecting a trapping laser into a first direction and a second direction to form the optical trap array, the optical trap generator coupled to the scheduling optimizer to receive the optimized atom schedule and move a set of atoms of the array of atoms between the doublons in the interaction zone and the storage zone in the optical trap array responsive to the optimized atom schedule.

2. The system of claim 1, wherein the quantum computation comprises executing one of a quantum circuit, a quantum error correction, and a logical algorithm.

3. The system of claim 1, wherein the plurality of zones further comprises a reload zone, a qubit preparation zone, a single qubit gate zone, a measurement zone, and a cooling zone.

4. The system of claim 1, wherein the array of atoms comprises neutral atoms.

5. The system of claim 4, wherein the array of atoms comprises ytterbium.

6. The system of claim 1, wherein the interaction zone geometry comprises a 2 by 8 doublon array and the storage zone geometry comprises a 28 by 16 register array.

7. The system of claim 1, wherein the optical trap generator includes a crossed acousto-optic deflector (xAOD) and a spatial light modulator (SLM) coupled to the trapping laser and a polarizing beam splitter (PBS) to form the optical trap array.

8. The system of claim 7, wherein the xAOD forms a set of mobile optical tweezers to move the set of atoms between the doublons in the interaction zone and the storage zone, and the SLM forms a set of fixed optical tweezers to generate the doublons.

9. The system of claim 1, wherein the scheduling optimizer further includes an annealing solver and a mathematical optimization engine.

10. A method for configuring an array of atoms for performing a quantum computation, the method comprising:
providing a quantum register including an optical trap array having a plurality of zones, the plurality of zones including an interaction zone and a storage zone;
receiving a plurality of constraints at a scheduling optimizer;
determining by the scheduling optimizer, an optimized atom schedule that optimizes a value of an objective function that correlates to minimizing a logical error rate while performing the quantum computation and respecting the plurality of constraints including:
hardware constraints that include an interaction zone geometry based on doublons, a storage zone geometry, and movement constraints within the array of atoms between the interaction zone and the storage zone, the interaction zone geometry including the doublons,
circuit scheduling that includes initial qubit placement in the optical trap array, gate groupings in the doublons in the interaction zone, and
qubit groupings for simultaneous moves between the interaction zone and the storage zone; and
receiving the optimized atom schedule by an optical trap generator coupled to the scheduling optimizer;
deflecting a trapping laser into a first direction and a second direction to form the optical trap array using the optical trap generator; and
moving the array of atoms by the optical trap generator between the doublons in the interaction zone and the storage zone in the optical trap array responsive to the optimized atom schedule.

11. The method of claim 10, further comprising executing one of a quantum circuit, a quantum error correction, and a logical algorithm.

12. The method of claim 10, wherein the plurality of zones further comprises a reload zone, a qubit preparation zone, a single qubit gate zone, a measurement zone, and a cooling zone.

13. The method of claim 10, wherein the array of atoms comprises neutral atoms.

14. The method of claim 10, wherein the array of atoms comprises ytterbium.

15. The method of claim 12, further comprising forming the optical trap generator using a crossed acousto-optic deflector (xAOD) and a spatial light modulator (SLM) coupled to the trapping laser and a polarizing beam splitter (PBS) to form the optical trap array.

16. The method of claim 15, further comprising:
forming a set of mobile optical tweezers to move the array of atoms between the doublons in the interaction zone and the storage zone using the xAOD; and
forming a set of fixed optical tweezers using the SLM to generate the doublons.

17. The method of claim 10, the scheduling optimizer further including an annealing solver and a mathematical optimization engine.

18. A neutral atom quantum computer having a zoned architecture comprising an interaction zone including doublons, and a storage zone, the neutral atom quantum computer comprising:
a quantum register including an optical trap array having a plurality of zones, the plurality of zones including the interaction zone and the storage zone;
a scheduling optimizer for receiving a plurality of constraints and determining an optimized atom schedule that optimizes a value of an objective function that correlates to minimizing a logical error rate while performing a quantum computation and respecting the plurality of constraints including:
hardware constraints that include an interaction zone geometry, a storage zone geometry, and movement constraints within an array of atoms between the interaction zone and the storage zone, the interaction zone geometry including the doublons, and
circuit scheduling that includes initial qubit placement in the optical trap array, gate groupings in the doublons in the interaction zone, and
qubit groupings for simultaneous moves between the interaction zone and the storage zone; and
an optical trap generator for deflecting a trapping laser into a first direction and a second direction to form the optical trap array, the optical trap generator coupled to the scheduling optimizer to receive the optimized atom schedule and move the array of atoms between the doublons in the interaction zone and the storage zone in the optical trap array responsive to the optimized atom schedule.

19. The neutral atom quantum computer of claim 18, the optical trap generator comprising a crossed acousto-optic deflector (xAOD) and a spatial light modulator (SLM) coupled to the trapping laser and a polarizing beam splitter (PBS) to form the optical trap array.

20. The neutral atom quantum computer of claim 19, wherein the xAOD forms a set of mobile optical tweezers to move the array of atoms between the doublons in the interaction zone and the storage zone and the SLM forms a set of fixed optical tweezers to generate the doublons.
